(19) United States
(12) Patent Application Publication
(10) Pub. No.: US 2019/0382127 A1
(43) Pub. Date: Dec. 19, 2019

(54) DAMAGED PORTION DETERMINATION DEVICE, DAMAGED PORTION DETERMINATION SYSTEM PROVIDED WITH THE SAME, AND DAMAGED PORTION DETERMINATION METHOD AND PROGRAM

(71) Applicant: MITSUBISHI HEAVY INDUSTRIES, LTD., Tokyo (JP)

(72) Inventors: Takashi Yari, Tokyo (JP); Nozomi Saito, Tokyo (JP); Nobuhiro Higuchi, Tokyo (JP)

(73) Assignee: MITSUBISHI HEAVY INDUSTRIES, LTD., Tokyo (JP)

(21) Appl. No.: 16/488,326

(22) PCT Filed: Feb. 22, 2018
(86) PCT No.: PCT/JP2018/006383

§ 371 Date: Aug. 23, 2019

(30) Foreign Application Priority Data
Feb. 27, 2017 (JP) 2017-035025

(51) Int. Cl. B64D 45/00; B64F 5/40; B64F 5/60

(52) U.S. Cl. CPC B64D 45/00; B64D 2045/0085; B64F 5/60; B64F 5/40

(57) ABSTRACT

A damaged portion determination device includes: a damage identification unit that identifies a damaged portion of an airframe of an aircraft; a position identification unit that identifies a reference position inside the airframe of the aircraft; and a damaged portion presentation unit that superimposes and presents an imaging result resulting from imaging of a state inside the airframe of the aircraft at the reference position by an imaging device, internal structural data representing an internal structure of the aircraft, and position information about the damaged portion relative to the reference position.

### TECHNICAL FIELD

The present invention relates to a damaged portion determination device, a damaged portion determination system provided with it, and damaged portion determination method and program.

### BACKGROUND ART

Conventionally, the inspection and repair of the structure of an aircraft have been made as sequential works. Damaged portions are recognized during the inspection, and after the setting of repair methods, the repairs are made at the same portions. For a periodic inspection, at timing of a periodic period or a periodic number of flights, after the interior equipment elements of the aircraft have been removed, the inspection is made while an ultrasound examination or the like is made on parts one by one.

In Patent Citation 1 below, there is described a method for displaying work places at the time of the assembly of an aircraft and workplaces at the time of the maintenance of the aircraft.

Patent Citation 1: Japanese Unexamined Patent Application, Publication No. 2014-201307

### DISCLOSURE OF INVENTION

By the way, in conventional inspections, at timing of every execution of a periodic inspection, all interior equipment elements of an aircraft are removed, and then, the inspection is started. Repair methods are set in accordance with the result of the inspection and repairs by a worker are made. Further, after the completion of the repairs, the interior equipment elements are restored. For this reason, a period from the removal of the interior equipment elements inside the aircraft until the restoration thereof has resulted in a downtime of the aircraft.

Thus, as a method of shortening the downtime of the aircraft, it is considered to apply a structural health monitoring (hereinafter also referred to as “SHM”) technique when a diagnosis on the structural health of the aircraft is made. When the SHM technique is applied, vicinities of repair portions corresponding to the damaged portions are treated as inspection targets, and thus, the removal of the interior equipment elements of the entire aircraft becomes unnecessary, thereby enabling the repairs to be made in a way that allows for a removal of only interior equipment elements disposed in the vicinities of the repair portions.

It is assumed that information about each of the damaged portions having been obtained by the SHM technique is represented by a part number or coordinates of a part. In the case of a structure in which a similar shape continuously extends, such as a fuselage portion of a civilian aircraft, however, there is a problem in that it takes a long time to determine the damaged portions, each being represented by the part number or coordinates, on the airframe.

Meanwhile, in a method in Patent Citation 1 above, the use of damage information output from a structural health monitoring device is not described. In the case of such a method in Patent Citation 1 above, if the damage information output from the structural health monitoring device is used, the problem in that it takes a long time to specify the positions on the airframe could not be solved.

The present invention has been made in view of such a circumstance, and intends to provide a damaged portion determination device, a damaged portion determination system provided with it, and damaged portion determination method and program that are capable of shortening an aircraft downtime taken to repair a damaged portion.

In order to solve the above problem, the present invention employs the following means.

The present invention provides a damaged portion determination device including a damage identification unit that identifies a damaged portion of an airframe of an aircraft; a position identification unit that identifies a reference position inside the airframe of the aircraft; and a damaged portion presentation unit that superimposes and presents an imaging result resulting from imaging of a state inside the airframe of the aircraft at the reference position by an imaging device, internal structural data representing an internal structure of the aircraft, and position information about the damaged portion relative to the reference position.

According to the above configuration of the present invention, upon identification of a damaged portion of the airframe of the aircraft, an imaging result resulting from imaging of a state inside the airframe of the aircraft at the reference position inside the airframe of the aircraft, internal structural data for the aircraft, and the damaged portion are superimposed and presented.

With this configuration, a worker attempting to repair the damaged portion of the aircraft is able to easily determine the damaged portion on the internal structure of the aircraft based on the contents presented by the damaged portion presentation unit. By enabling the damaged portion to be easily determined, a work for removing interior components mounted inside the airframe is needed in only a portion associated with the damaged portion. With this configuration, a repair time can be made shorter than that in the conventional method in which all interior components are removed.

Further, by enabling the confirmation of the internal structure and the damaged portion before the removal of the interior components inside the airframe, it is prevented that the worker mistakes the position.

The above damaged portion determination device may further include a guidance unit that guides a guidance target to the damaged portion presented by the damaged portion presentation unit.

By being guided to the damaged portion, a worker attempting to repair the damaged portion is able to easily reach the damaged portion.

The above damaged portion determination device may further include a storage device that stores in itself repair information about a repair method for the damaged portion of the aircraft, and a repair method presentation unit that, based on the repair information, presents the repair method for the damaged portion presented by the damaged portion presentation unit.

By allowing the repair method to be presented, preliminary arrangements needed in a repair work can be made in advance, and steps associated with the whole of repairs can be reduced.

At least one interior equipment element may be mounted in the aircraft associated with the above damaged portion determination device.

An aircraft with its interior equipment elements mounted at the time of its flight disposed is in a state in which the damaged portion is hidden by the interior equipment elements. According to the present invention, an imaging result resulting from imaging of a state inside the airframe by an imaging device, and internal structural data representing the internal structure of the aircraft are superimposed, and thus, even in such an aircraft with its interior equipment elements mounted, the damaged portion can be easily determined.

Note that, in the present invention, even in a state in which all of the interior equipment elements are mounted, the present invention enables the damaged portion to be determined.

The present invention provides a damaged portion determination system including the damaged portion determination device having any one of the above-described configurations, and an aircraft.

The present invention provides a damaged portion determination method for guiding from a current position to a damaged portion of an aircraft, the damaged portion determination method including a first step of identifying the damaged portion of an airframe of the aircraft; a second step of identifying a reference position inside the airframe of the aircraft; a third step of superimposing and presenting an imaging result resulting from imaging of a state inside the airframe of the aircraft at the reference position by an imaging device, internal structural data representing an internal structure of the aircraft, and position information about the damaged portion relative to the reference position; and a fourth step of guiding a guidance target to the damaged portion having been presented by the third step.

The present invention provides a damaged portion determination program for guiding from a current position to a damaged portion of an aircraft, the damaged portion determination program allowing a computer to execute first processing for identifying the damaged portion of an airframe of the aircraft; second processing for identifying a reference position inside the airframe of the aircraft; third processing for superimposing and presenting an imaging result resulting from imaging of a state inside the airframe of the aircraft at the reference position by an imaging device, internal structural data representing an internal structure of the aircraft, and position information about the damaged portion relative to the reference position; and fourth processing for guiding a guidance target to the damaged portion having been presented by the third processing.

The present invention brings about advantageous effects that a worker is able to easily reach a damaged portion, and an aircraft downtime taken to make a repair can be shortened.

### BRIEF DESCRIPTION OF DRAWINGS

FIG. 1 is a perspective view of an aircraft associated with the present invention.

FIG. 2 is a functional block diagram of a damaged portion determination system according to the present invention.

FIG. 3 is an operation flow of the damaged portion determination system according to the present invention.

FIG. 4 is an example display screen of a display device of the damaged portion determination system according to the present invention.

FIG. 5 is a diagram illustrating a flow at the time when a repair portion is displayed on the display device.

FIG. 6 is a diagram illustrating a flow at the time when the display device is allowed to perform displaying by a navigation function.

FIG. 7 is a functional block diagram of a damaged portion determination system according to a modification of the present invention.

### BEST MODE FOR CARRYING OUT THE INVENTION

Hereinafter, an embodiment of a damaged portion determination device, a damaged portion determination system provided with it, and damaged portion determination method and program according to the present invention will be described with reference to the drawings.

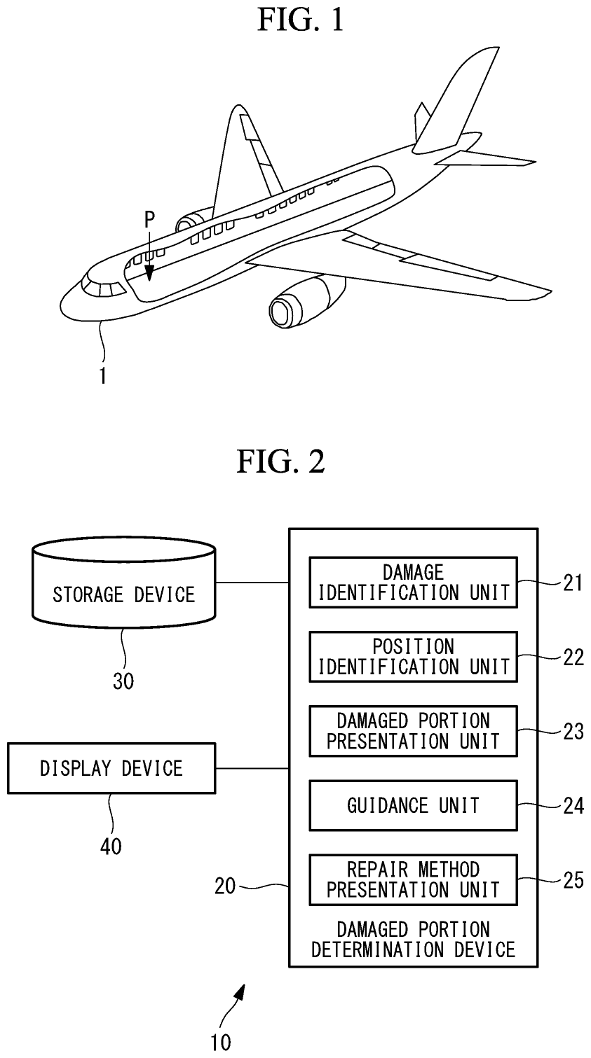

FIG. 1 is a perspective view of an aircraft 1, which becomes an inspection target, illustrating a state in which the inside of the aircraft 1 is visible. This description will be made by taking as an example a case in which the aircraft 1, which is the subject of the present embodiment, is an aircraft in which interior equipment elements (omitted from illustration) are mounted, and which is an aircraft that has previously experienced its flight even once, or an aircraft that is already in a state of being ready to make a flight, but the present invention is not limited to this example. For example, the present invention is applicable to even the aircraft 1 in which no interior equipment element is mounted.

FIG. 2 illustrates a functional block diagram resulting from mainly extracting functions of presenting damaged portions of an aircraft among various functions included in a damaged portion determination system 10. The damaged portion determination system 10 includes a damaged portion determination device 20, a storage device 30, and a display device 40.

As illustrated in FIG. 2, the damaged portion determination device 20 is, for example, a computer, and includes a CPU; ROM (Read Only Memory) for storing therein programs executed by the CPU, and the like; RAM (Random Access Memory) that functions as work areas at the time of the execution of the individual programs; and the like. A procedure of a series of processing for implementing various functions described later is recorded in a recording medium or the like in the form of programs (for example, a damaged portion determination program), and the various functions described later are implemented by allowing the CPU to read the programs into the RAM or the like, and execute processes/arithmetic processing on information.

The damaged portion determination device 20 includes a damage identification unit 21, a position identification unit 22, a damaged portion presentation unit 23, a guidance unit 24, and a repair method presentation unit 25.

The damage identification unit 21 identifies damaged portions of the airframe of the aircraft 1. For example, the damage identification unit 21 identifies position information about the damaged portions of the airframe such that acceleration sensors or the like are disposed in the aircraft 1 (a structure), and data that, at the time when a flight of the aircraft 1 is made, is obtained by structural health monitoring (SHM) device for diagnosing structural performance from response waveforms obtained from the acceleration sensors is input to the damage identification unit 21.

Note that the identification of the damaged portions is not limited to the use of the data from the structural health monitoring device, and any information capable of identifying the damaged portions may be used.

The position identification unit 22 identifies a reference position P (see FIG. 1) inside the airframe of the aircraft 1. For example, the position identification unit 22 receives an optical beacon, a radio wave beacon, or the like that is emitted from a predetermined position inside the airframe; detects a position at which a worker exists based on the received beacon; and determines the position at which the worker exists as the reference position P. Further, the position identification unit 22 may identify a reference position associated with the aircraft 1 and having been input by a worker or the like via an input/output device (omitted from illustration). The reference position P is a position that becomes a reference at the time when states inside the airframe are imaged in the damaged portion presentation unit 23.

The damaged portion presentation unit 23 superimposes and presents an imaging result resulting from imaging of a state inside the airframe of the aircraft 1 at the reference position P by an imaging device, internal structural data representing the internal structure of the aircraft 1, and position information about one or more damaged portions relative to the reference position P. Note that the damaged portion presentation unit 23 may obtain the imaging results in such a way as to allow imaging results having been obtained by an external imaging device to be input to the damaged portion determination device 20. Further, the damaged portion presentation unit 23 may retrieve and obtain imaging results stored in the storage device 30. Further, when the storage device 30 stores therein the imaging results, information about the reference position P is preferable to be additionally stored together with the imaging results.

The guidance unit 24 is a known navigation system, and has a navigation function of guiding a guidance target (for example, a worker) to each of the one or more damaged portions having been presented by the damaged portion presentation unit 23. For example, the guidance unit 24 identifies a current position, and the direction in which the worker orients himself or herself toward the airframe, and indicates the one or more damaged portions relative to the airframe to the worker. Note that, for the navigation function, position identification by acceleration accumulation may be made or position identification by a beacon may be made, and a method of implementing the navigation function is not particularly limited.

By allowing the position of each of the one or more damaged portions relative to the airframe to be indicated to the worker using the navigation function, the worker is able to determine each of the one or more damaged portions easily and promptly.

The repair method presentation unit 25 presents a repair method for each of the one or more damaged portions presented by the damaged portion presentation unit 23 based on repair information having been retrieved from the storage device 30.

In the storage device 30, information about repair methods for repairing damage of the damaged portions of the aircraft 1 is stored. The information about the repair methods is retrieved from the storage device 30 by the damaged portion determination device 20 when needed. Further, the storage device 30 stores therein internal structural data (for example, 3D-CAD data) representing the internal structure of the aircraft 1. The internal structure of the aircraft 1 is in a hidden state when the interior equipment elements are mounted.

The display device 40 superimposes and displays an imaging result resulting from imaging of a state inside the airframe from the reference position P, internal structural data for the aircraft 1, and position information about one or more damaged portions. Further, the display device 40 performs displaying in such a way as to allow a repair method for repairing damage of each of the one or more damaged portions to be associated with information about the each damaged portion.

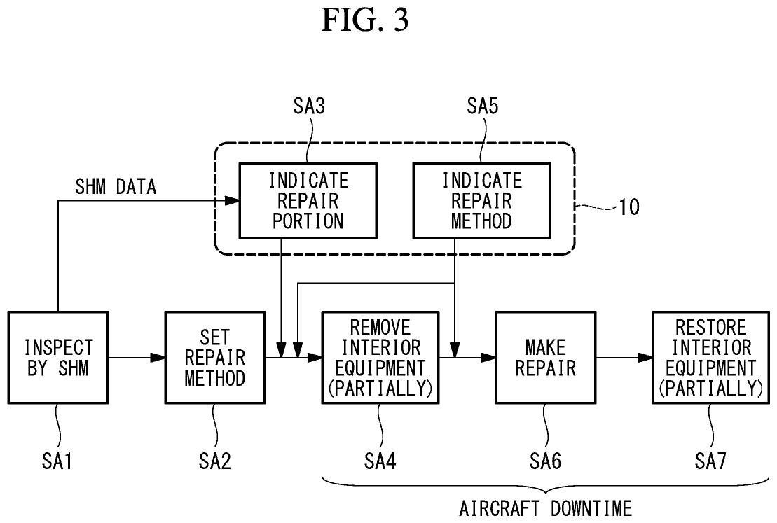

Hereinafter, the operation of the damaged portion determination system 10 according to the present embodiment will be described with reference to FIGS. 3 to 6. FIG. 3 is a diagram that describes a sequential flow of presenting damaged portions on the airframe to a worker; making guidance; and making repairs, using a damaged portion determination system.

The damaged portion determination device 20 obtains SHM data having been obtained by the structural health monitoring device (step SA1 in FIG. 3). Information about damaged portions having been identified based on the SHM data is presented to the display device 40. Upon discrimination of the damaged portions, repair methods for repairing damage of the damaged portions are determined (set) (step SA2 in FIG. 3).

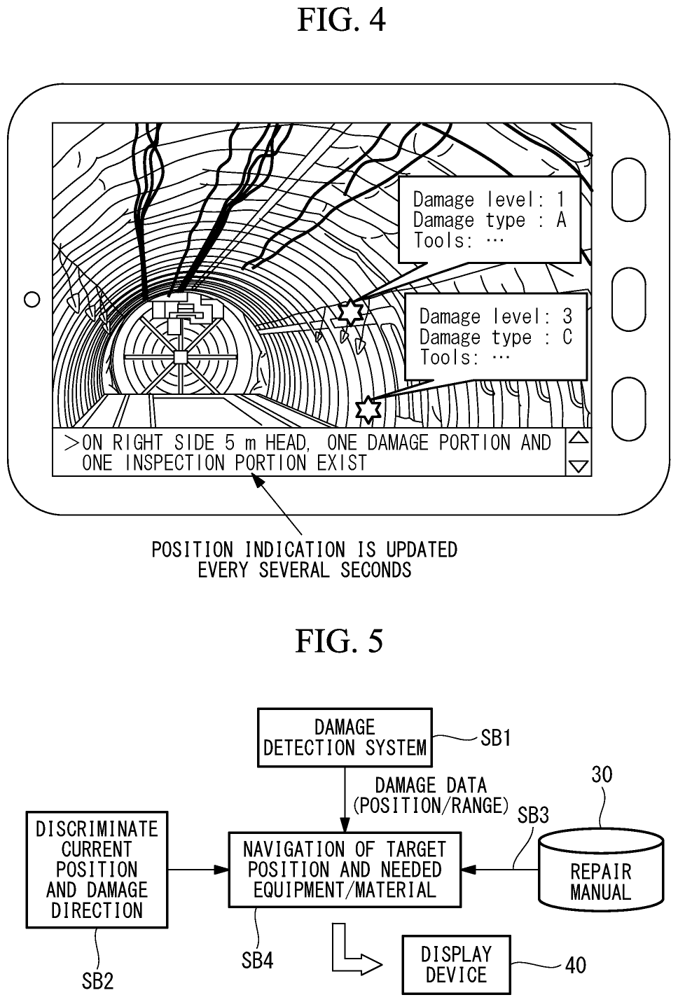

A current position of the worker is detected and this current position is determined as the reference position P. The worker orients himself or herself from the reference position P toward one or more damaged portions of the airframe. In a state in which the interior equipment elements are mounted inside the airframe (before the removal of the interior equipment elements), the worker takes an image from the reference position P toward the one or more damaged portions using an imaging device to obtain an imaging result. The imaging result, internal structural data for the airframe having been retrieved from the storage device 30, and information about the one or more damaged portions are superimposed and displayed on the display device 40, and one or more repair portions are indicated (step SA3 in FIG. 3). In FIG. 4, there is illustrated an example display of the display device 40, in which an imaging result, internal structural data, and information about damaged portions are superimposed and displayed. With this configuration, the position relation between the current position and each of the one or more damaged portions (see, for example, star-shaped signs in FIG. 4) is visually displayed on the display device 40. Further, a repair method and a list of necessary tools for each of the one or more damaged portions are displayed with a comment balloon.

Further, as illustrated in FIG. 4, a position indication that indicates at which position on the airframe relative to the current position each of the one or more damaged portions exists is displayed at a lower portion of the window of the display device 40, and the position indication is updated every several seconds. By allowing the position of each of the one or more damaged portions to be presented in the form of not only an image, but also a string of characters (a description), the worker is able to easily reach each of the one or more damaged portions.

The worker is guided to the position of each of the one or more damaged portions by the navigation function. When having been guided to the position of each of the one or more damaged portions based on the superimposed display of the imaging result, the internal structural data, and the information about the one or more damaged portions, the worker is able to specify, at the position of each of one or more guidance destinations, an actual position that lies on the airframe and that becomes one of removal portions at which interior equipment elements needed to be removed for the repairs of the damaged portions are removed. The interior equipment elements in the above-described removal portions (partial interior equipment elements of the airframe) are removed by the worker (step SA4 in FIG. 3).

Repair methods are presented to the display device 40 (step SA5 in FIG. 3). Here, the presentation of the repair methods may be made at timing when the one or more repair portions are indicated (step SA3 in FIG. 3), or may be made at timing after the partial interior equipment elements have been removed.

The repairs of repair portions are made by the worker based on the repair methods having been presented to the display device 40 (step SA6 in FIG. 3). Upon completion of the repairs, the partial interior equipment elements, which were removed by the worker, are restored (step SA7 in FIG. 3).

In this way, according to the present embodiment, a period from step SA4 to step SA7 in FIG. 3 results in a downtime of the aircraft of the aircraft 1. Conventionally, a flow has been such that, after all interior equipment elements inside the airframe have been removed, an inspection is made; repair methods are set; repairs are made; and the all interior equipment elements are restored. Thus, a situation in which the downtime of the aircraft continues over a long period from the removal of the all interior equipment elements inside the airframe until the restoration thereof has been occurring. According to the present embodiment, the downtime of the aircraft can be made shorter than that in such a conventional method.

In FIG. 5, there is illustrated a flow of the display of a display device at the time when the navigation function is used. As illustrated in FIG. 5, damage data including information about damage positions and damage ranges of the aircraft 1 and detected in a damage detection system employing the SHM technique or the like is input (step SB1 in FIG. 5). Further, information about the current position is detected by the known navigation function, and information resulting from discriminating damage directions represented by the damage data is input (step SB2 in FIG. 5).

The damaged portion determination device 20 obtains information about damage positions on the airframe (step SB4 in FIG. 5). Further, by allowing a repair manual to be retrieved from the storage device 30, information about equipment and materials that are needed to repair damage occurring on the airframe is extracted (step SB3 in FIG. 5). The damaged portion determination device 20 displays the information about the equipment and materials that are needed to make repairs (step SB4 in FIG. 5). Further, paths to the damage positions are displayed on the display device 40 on a real time basis by the navigation function.

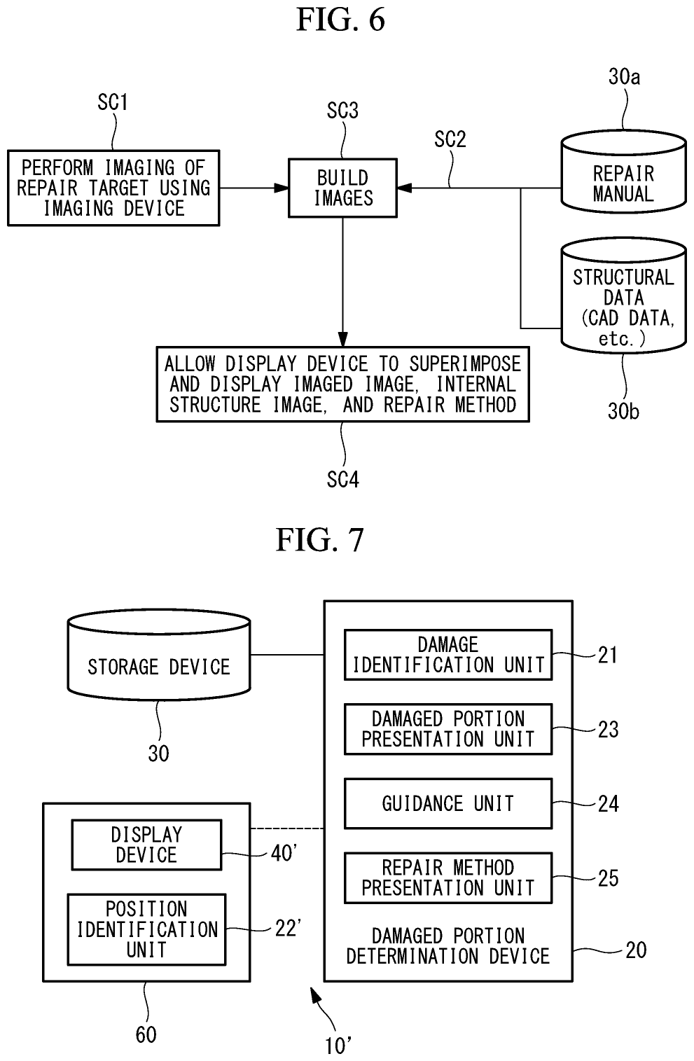

In FIG. 6, there is illustrated a flow of works at the time when repair portions are determined by a display device.

Areas each covering one or more repair targets are imaged using an imaging device (step SC1 in FIG. 6). A repair manual is retrieved from a storage unit 30a, and internal structural data (for example, CAD data) for the aircraft 1 is retrieved from a storage unit 30b (step SC2 in FIG. 6). Images each obtained by superimposing one of the imaging results having been obtained from the imaging device, the repair manual, and the internal structural data (images each obtained by allowing the internal structure to be displayed as if the internal structure were transparently seen, in such a way as to allow the internal structural data to be superimposed on, for example, an image resulting from imaging interior equipment elements of the airframe) are built (step SC3 in FIG. 6). One imaged image, the internal structural data, and one or more repair methods for the one or more damaged portions are superimposed and displayed on the display device (step SC4 in FIG. 6).

Note that a storage device for storing therein the repair manual and a storage device for storing therein the structural data are separately illustrated in FIG. 6, but the present invention is not limited to this configuration, and the repair manual and the structural data may be stored in a single storage device.

As having been described above, according to the damaged portion determination device 20 according to the present embodiment; the damaged portion determination system 10 provided with it; and damaged portion determination method and program, upon identification of damaged portions of the airframe of the aircraft 1, an imaging result resulting from imaging a state inside the airframe of the aircraft 1 at the reference position P inside the airframe of the aircraft 1, internal structural data for the aircraft 1, and one or more damaged portions are superimposed and presented.

With this configuration, a worker attempting to repair the damaged portions of the aircraft 1 is able to easily determine the damaged portions on the internal structure of the aircraft 1 based on the contents presented by the damaged portion presentation unit 23. By enabling the damaged portions to be easily determined, a work for removing interior components mounted inside the airframe is need in only portions associated with the damaged portions. A repair time can be made shorter than that in the conventional method in which all interior components are removed.

Further, by enabling the internal structure and the damaged portions to be confirmed before the removal of the interior components inside the airframe, it is prevented that the worker mistakes the positions. Further, by being provided with the navigation function of guiding to the damaged portions, the worker attempting to repair the damaged portions is able to easily reach the damaged portions.

Moreover, by allowing the repair methods to be presented, preliminary arrangements needed in repair works can be made in advance, and steps associated with the whole of repairs can be reduced.

[Modification]

In the above embodiment, the damaged portion determination system 10 has been described as a configuration including the damaged portion determination device 20, the storage device 30, and the display device 40, but the present invention is not limited to this configuration. For example, as illustrated in FIG. 7, a damaged portion determination system 10′ may be configured to include the damaged portion determination device 20; a portable type device 60 including a position identification unit 22′ and a display device 40′; and the storage device 30.

The damaged portion determination device 20 includes elements other than the position identification unit 22 among the elements illustrated in FIG. 2. Each of the damaged portion determination device 20 and the portable type device 60 is provided with a communication medium capable of performing radio communication, and by allowing the damaged portion determination device 20 and the portable type device 60 to mutually transmit/receive information via the radio communication, the same functions as those of the above embodiment are implemented. The individual units' rolls are the same as those of the above-described embodiment, and thus the description thereof is omitted.

By, in this way, allowing the portable type device 60 to include the position identification unit 22′ and the display device 40′, and enabling minimum necessary elements in the presentation of the damaged portions of the aircraft 1 to be carried, the weight of carried objects is lightened, and burdens on the worker is reduced.

Heretofore, the embodiment of the present invention has been described in detail with reference to the drawings, but specific configurations are not limited to this embodiment, and design changes and the like not departing from the scope of the present invention are also included. For example, in the above embodiment, for a reference position identified by the position identification unit 22, a position at which a worker exists is detected using a beacon and this position is determined as the reference position P. Without being limited to this configuration, the position identification unit 22 may determine, as the reference position P, a position that is set in advance in the aircraft 1; a worker may move to the reference position P having been set in advance; and after the movement to the reference position P, the worker may take an image inside the airframe. By, in this way, setting the reference position P in advance onto a predetermined position, a period of time taken to detect the current position of the worker can be shortened.

### REFERENCE SIGNS LIST

1 aircraft

10, 10′ damaged portion determination system

20 damaged portion determination device

21 damage identification unit

22, 22′ position identification unit

23 damaged portion presentation unit

24 guidance unit

25 repair method presentation unit

30 storage device

40, 40′ display device

1. A damaged portion determination device comprising:
a damage identification unit that identifies a damaged portion of an airframe of an aircraft;
a position identification unit that identifies a reference position inside the airframe of the aircraft; and
a damaged portion presentation unit that superimposes and presents an imaging result resulting from imaging of a state inside the airframe of the aircraft at the reference position by an imaging device, internal structural data representing an internal structure of the aircraft, and position information about the damaged portion relative to the reference position.

2. The damaged portion determination device according to claim 1, further comprising a guidance unit that guides a guidance target to the damaged portion presented by the damaged portion presentation unit.

3. The damaged portion determination device according to claim 1, further comprising:
a storage device that stores in itself repair information about a repair method for the damaged portion of the aircraft; and
a repair method presentation unit that, based on the repair information, presents the repair method for the damaged portion presented by the damaged portion presentation unit.

4. The damaged portion determination device according to claim 1, wherein at least one interior equipment element is mounted in the aircraft.

5. A damaged portion determination system comprising:
the damaged portion determination device according to claim 1; and an aircraft.

6. A damaged portion determination method for guiding from a current position to a damaged portion of an aircraft, the damaged portion determination method comprising:
a damage identification step of identifying the damaged portion of an airframe of the aircraft;
a position identification step of identifying a reference position inside the airframe of the aircraft;
a damaged portion presentation step of superimposing and presenting an imaging result resulting from imaging of a state inside the airframe of the aircraft at the reference position by an imaging device, internal structural data representing an internal structure of the aircraft, and position information about the damaged portion relative to the reference position; and
a guiding step of guiding a guidance target to the damaged portion having been presented by the damaged portion presentation step.

7. A damaged portion determination program for guiding from a current position to a damaged portion of an aircraft, the damaged portion determination program allowing a computer to execute:
damage identification processing for identifying the damaged portion of an airframe of the aircraft;
position identification processing for identifying a reference position inside the airframe of the aircraft;
damaged portion presentation processing for superimposing and presenting an imaging result resulting from imaging of a state inside the airframe of the aircraft at the reference position by an imaging device, internal structural data representing an internal structure of the aircraft, and position information about the damaged portion relative to the reference position; and
guiding processing for guiding a guidance target to the damaged portion having been presented by the damaged portion presentation processing.
